(19) United States
(12) Patent Application Publication
(10) Pub. No.: US 2023/0407778 A1
(43) Pub. Date: Dec. 21, 2023

(54) THEFT DETECTION SYSTEM FOR CATALYTIC CONVERTER

(71) Applicant: Stombaugh Peterson & Peal LLC, Anoka, MN (US)

(72) Inventors: Duane Merle Stombaugh, Spring Lake Park, MN (US); Timothy Joel Stombaugh, St. Cloud, MN (US); Dirk William Peterson, Ramsey, MN (US); James Wilson Peal, Brooklyn Park, MN (US)

(21) Appl. No.: 17/844,693

(22) Filed: Jun. 20, 2022

(51) Int. Cl. F01N 13/18; B60R 25/01

(52) U.S. Cl. CPC F01N 13/1822; F01N 13/1855; B60R 25/01; F01N 2260/22

(57) ABSTRACT

A theft detection system includes a sensor having a magnetic ball axially moveably supported within an axial opening in the spool having an electrical coil wound around the spool such that movement of the ball creates electrical signals in the coil. A housing is configured to support and vibrationally couple the sensor to a vehicle exhaust system. A circuit is coupled to the electrical coil to receive the electrical signals and generate an alarm signal in response to movement of the ball being indicative of vibration of the exhaust system resulting from exhaust system tampering.

### BACKGROUND

Theft detection systems for catalytic converters can rely on vibration sensors, motion sensors, temperature sensors, and short circuit detection sensors. Vibration sensors can utilize accelerometers that may be adversely affected by heat generated from catalytic converters while an engine running. Over time, such sensors may fail due to heat exposure. Other types of sensor may be easily bypassed.

Prior art vibration sensors typically utilize ball or reed type switches that open or close a contact when they are vibrated or moved. Unfortunately, these types of sensors often cause false alarms because they cannot distinguish between vibrations that occur due to normal causes and those that occur due to attempted theft of a catalytic converter. Such sensors may create false alarms in response to vibrations caused by a car door being closed or other normal driver or passenger interactions with the car, such as loading luggage or even washing the car. Even thunder, wind, hail or other environmental conditions may trigger a false alarm.

### SUMMARY

A theft detection system includes a sensor having a magnetic ball axially moveably supported within an axial opening in the spool having an electrical coil wound around the spool such that movement of the ball creates electrical signals in the coil. A housing is configured to support and vibrationally couple the sensor to a vehicle exhaust system. A circuit is coupled to the electrical coil to receive the electrical signals and generate an alarm signal in response to movement of the ball being indicative of vibration of the exhaust system resulting from exhaust system tampering.

### BRIEF DESCRIPTION OF THE DRAWINGS

FIG. 1 is a block diagram of a theft detection system according to an example embodiment.

FIG. 2 is side elevation block diagram of an installed theft detection system according to an example embodiment.

FIG. 3 is a block representation of an installed theft detection system according to an example embodiment.

FIG. 4 is a block representation of a reciprocating saw positioned to cut through pipe according to an example embodiment.

FIG. 5 is a block schematic diagram of circuitry used for processing signals received from a coil in response to movement of magnetic ball axially within cylinder according to an example embodiment.

FIG. 6 is a flowchart illustrating a circuitry implemented method of detecting vibrations associated with theft of a catalytic converter according to an example embodiment.

FIG. 7 is a block schematic diagram of a computer system to implement one or more example embodiments.

### DETAILED DESCRIPTION

In the following description, reference is made to the accompanying drawings that form a part hereof, and in which is shown by way of illustration specific embodiments which may be practiced. These embodiments are described in sufficient detail to enable those skilled in the art to practice the invention, and it is to be understood that other embodiments may be utilized and that structural, logical and electrical changes may be made without departing from the scope of the present invention. The following description of example embodiments is, therefore, not to be taken in a limited sense, and the scope of the present invention is defined by the appended claims.

The functions or algorithms described herein may be implemented in software in one embodiment. The software may consist of computer executable instructions stored on computer readable media or computer readable storage device such as one or more non-transitory memories or other type of hardware-based storage devices, either local or networked. Further, such functions correspond to modules, which may be software, hardware, firmware or any combination thereof. Multiple functions may be performed in one or more modules as desired, and the embodiments described are merely examples. The software may be executed on a digital signal processor, ASIC, microprocessor, or other type of processor operating on a computer system, such as a personal computer, server or other computer system, turning such computer system into a specifically programmed machine.

The functionality can be configured to perform an operation using, for instance, software, hardware, firmware, or the like. For example, the phrase “configured to” can refer to a logic circuit structure of a hardware element that is to implement the associated functionality. The phrase “configured to” can also refer to a logic circuit structure of a hardware element that is to implement the coding design of associated functionality of firmware or software. The term “module” refers to a structural element that can be implemented using any suitable hardware (e.g., a processor, among others), software (e.g., an application, among others), firmware, or any combination of hardware, software, and firmware. The term, “logic” encompasses any functionality for performing a task. For instance, each operation illustrated in the flowcharts corresponds to logic for performing that operation. An operation can be performed using, software, hardware, firmware, or the like. The terms, “component,” “system,” and the like may refer to computer-related entities, hardware, and software in execution, firmware, or combination thereof. A component may be a process running on a processor, an object, an executable, a program, a function, a subroutine, a computer, or a combination of software and hardware. The term, “processor,” may refer to a hardware component, such as a processing unit of a computer system.

Furthermore, the claimed subject matter may be implemented as a method, apparatus, or article of manufacture using standard programming and engineering techniques to produce software, firmware, hardware, or any combination thereof to control a computing device to implement the disclosed subject matter. The term, “article of manufacture,” as used herein is intended to encompass a computer program accessible from any computer-readable storage device or media. Computer-readable storage media can include, but are not limited to, magnetic storage devices, e.g., hard disk, floppy disk, magnetic strips, optical disk, compact disk (CD), digital versatile disk (DVD), smart cards, flash memory devices, among others. In contrast, computer-readable media, i.e., not storage media, may additionally include communication media such as transmission media for wireless signals and the like.

Catalytic converter theft is commonly accomplished by using a reciprocating saw to cut portions of a vehicle exhaust system on either side of the converter. The cutting can normally be done in less than a minute. Such cutting creates vibrations that have a frequency in the 10-17 Hz range. An improved theft detection system includes a coil and magnetic ball-based sensor configured to produce electrical signals in response to such vibrations.

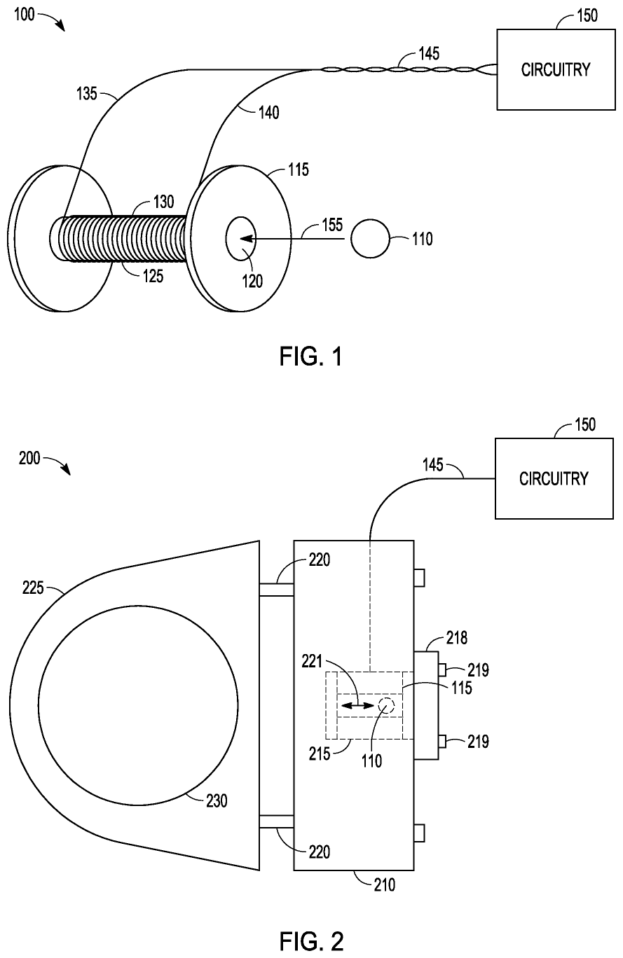

FIG. 1 is a block diagram of a theft detection system 100. In one example, a magnetic ball 110 is placed within an opening of a spool 115 that has an opening 120 forming a cylinder 125 that includes an electrically conductive coil 130 of insulated wire wound around the cylinder 125. The coil 130 may have 10 to 100 or more turns in one example. The magnetic ball 110 may be formed of neodymium or other magnetic material in one example.

Conductive leads 135, 140 coupled to the coil will conduct current generated as the ball 110 moves axially within the cylinder 125 in response to the vibrations. The leads 135 and 140 may be twisted as indicated at 145 and are coupled to circuitry 150 configured to detect the electrical signals and process the signals to generate an alarm. The spool may be coupled to a vehicle exhaust system on either side of a catalytic converter and positioned such that use of a reciprocating saw to cut part of the exhaust system causes vibrations along a lengthwise axis 155 (also shown as an arrow 155 to indicate insertion of the ball 110 into the cylinder 125) of the cylinder causing the ball to move back and forth lengthwise within the cylinder and transverse to the coil windings.

In one example the vibrations may be in the range of 10-17 Hz, with the size of the ball 110 and diameter of the cylinder 125 selected such that the ball moves axially in the cylinder 125 with vibrations in that frequency range. In one example, the coil 130 may be 0.65 inches long and the inner diameter of the cylinder may be 0.5 inches. The diameter of the magnetic ball 110 should be slightly less than the inner diameter of the cylinder 125.

FIG. 2 is side elevation block diagram of an installed theft detection system indicated generally at 200. Reference numbers in the figures are consistent between figures for like elements. In one example, a block 210 has an opening or hole 215 sized to fit the spool 115 and feed leads 145 to circuitry 150. A bottom 216 of hole 215 closes off one end of cylinder 125, and a plate 218 is attached to block 210 via screws or bolts 219 to seal off the other end of cylinder 125. The ball 110 can thus move through the cylinder along the axis of the cylinder as shown by arrow 221.

In one example, the block 210 is attached via bolts 220 and a U-shaped clamp 225 to a pipe 230 of an exhaust system. The block is rigidly coupled to the pipe 230 in one example such that vibrations of the pipe, such as vibrations caused by trying to saw through the pipe 230 in the same or similar direction to the axis of the cylinder are transmitted to the block, and spool 115. The axis of the spool 115 is positioned such that the vibrations imposed on the pipe 230 cause movement of the ball 110 within the cylinder and hence generate electrical signals in the coil 130 which are transmitted to the circuitry 150.

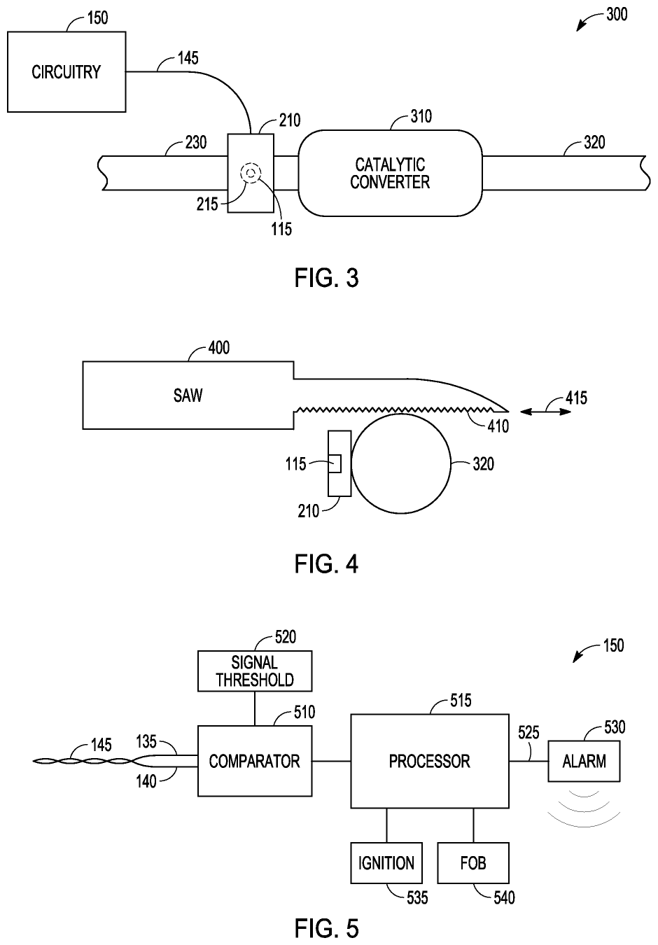

FIG. 3 is a block representation of an installed theft detection system indicated generally at 300. The theft detection system is installed such that the block 210 and spool 115 is coupled to pipe 230 of the exhaust system. The exhaust system includes a catalytic converter 310 and a further exhaust pipe 320. In further examples the block 210 may alternatively be coupled to further exhaust pipe 320 or may be positioned anywhere on the exhaust system that cutting to release the catalytic converter may generate vibrations that can be sensed.

FIG. 4 is a block representation of a reciprocating saw 400 positioned to cut through pipe 320. The saw 400 includes a blade 410 that is likely positioned on a top of pipe 320. Block 210 is also illustrated as attached to the pipe 320 and includes the spool 115 which is oriented with an axis aligned with a direction 415 of saw blade 410 motion.

FIG. 5 is a block schematic diagram of circuitry 150 used for processing signals received on leads 135, 140 from coil 130 in response to movement of ball 110 axially within cylinder 125 in response to vibrations. Leads 135, 140 are coupled to a comparator 510 for generating signals corresponding to logic levels that are coupled to a processor 515. A signal threshold 520 may be used to determine whether or not the logic level should represent 1 or a 0, with a 1 corresponding to motion of the ball causing a signal that exceeds the signal threshold value. The signal threshold value may be any value greater than zero, which corresponds to any detected movement of the ball 110.

In one example, an audio amplifier may be used as a comparator, with a first operational amplifier having positive and negative inputs directly coupled to leads 135 and 140. A second operational amplifier may be configured as a Schmidt trigger taking the output of the first operational amplifier as its input and outputting a square wave to the microprocessor 515. Positive values of the square wave occur when a signal is detected. The microprocessor 515 samples the square wave to determine whether or not the ball 110 was moving with respect to the coils 130 at the instant in time each sample is taken.

The processor, in a simple example, may operate to count the number of 1's over a period of time, and if the number exceeds a threshold number, to generate a signal on line 525 to sound an alarm 530. In further examples, processor 515 may generate alerts, such as electronic communications including emails or text messages regarding the alarm state.

In a further example, the processor 515 may receive signals from an ignition 535 of a vehicle in which the theft detection system is installed. In response to the signals being indicative of the vehicle engine running, the alarm may be suppressed. Such signals may also cause the processor to not bother processing sensor signals in one example. Similarly, the processor 515 may receive signals from a FOB 540 (a digital key) indicating the alarm should be turned off.

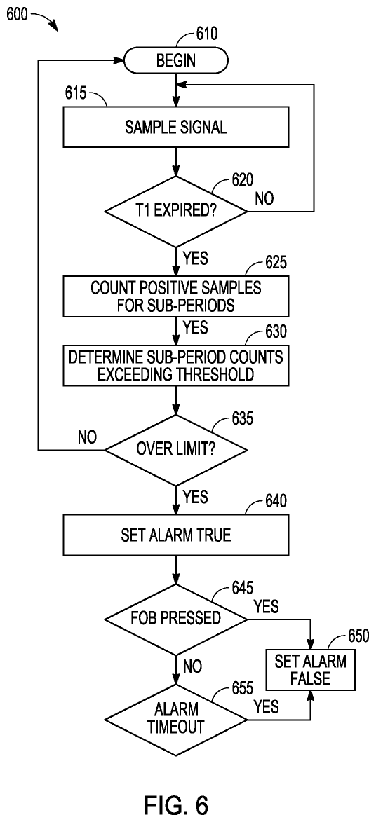

FIG. 6 is a flowchart illustrating a circuitry or computer implemented method 600 of detecting vibrations associated with theft of a catalytic converter. Method 600 may also be suitable for detecting many different forms of vibration in further examples. Ball and spool dimensions may be varied to be responsive to different ranges of frequencies as desired.

Method 600 begins at operation 610 by sampling the logic level signal generated from signals received from the coil 130 at operation 615. The signals may be sampled at a rate of several thousand signals per second in one example for a first time period, T1, and stored in a memory array. T1 may be one second in one example. If the end of the time period has not been reached at decision operation 620, sampling continues at operation 615.

Upon the time period, T1, expiring, processing continues at operation 625. The time period may be subdivided into multiple sub-periods, such as 8 sub-periods in one example. The number of samples that are positive or “1s” may be counted for each sub-period and compared to a sub-period threshold value to assign each sub-period a positive “1” or negative “0” value.

At operation 630, the number of sub-period positive samples counted exceeding the sub-period threshold value, such as 50%, may be determined. At decision operation 635, it is determined whether or not that number is over a limit, which again may be one half or 4 in one example. If yes, an alarm parameter or signal may be set to true at operation 640, which may cause an alarm to sound. At decision operation 645, if a FOB has been activated, such as by pressing a button to silence the alarm, the alarm parameter may be set to false at operation 650. Otherwise, if no, an alarm timeout is checked at decision operation 655 to determine if a time limit has expired for the alarm. If yes, operation 650 sets the alarm parameter to false, which causes the alarm to be silenced. If at operation 635, the number of sub-period counts did not exceed the limit, method 600 returns to begin 610 collecting and processing samples again. The above thresholds, time periods, and limits may be adjusted in various examples for either different alarm sensitivities or based on the characteristics of different vehicle exhaust systems.

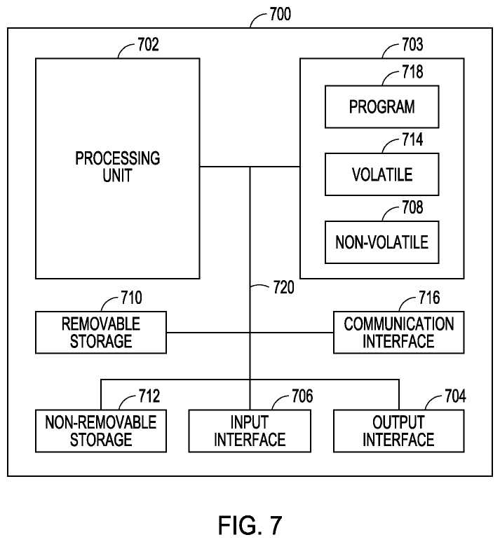

FIG. 7 is a block schematic diagram of a computer system 700 to process signals from a vibration sensor and for performing methods and algorithms according to example embodiments. All components need not be used in various embodiments.

One example computing device in the form of a computer 700 may include a processing unit 702, memory 703, removable storage 710, and non-removable storage 712. Although the example computing device is illustrated and described as computer 700, the computing device may be in different forms in different embodiments. For example, the computing device may instead be a smartphone, a tablet, smartwatch, smart storage device (SSD), or other computing device including the same or similar elements as illustrated and described with regard to FIG. 7. Devices, such as smartphones, tablets, and smartwatches, are generally collectively referred to as mobile devices or user equipment.

Although the various data storage elements are illustrated as part of the computer 700, the storage may also or alternatively include cloud-based storage accessible via a network, such as the Internet or server-based storage. Note also that an SSD may include a processor on which the parser may be run, allowing transfer of parsed, filtered data through I/O channels between the SSD and main memory.

Memory 703 may include volatile memory 714 and non-volatile memory 708. Computer 700 may include—or have access to a computing environment that includes—a variety of computer-readable media, such as volatile memory 714 and non-volatile memory 708, removable storage 710 and non-removable storage 712. Computer storage includes random access memory (RAM), read only memory (ROM), erasable programmable read-only memory (EPROM) or electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage or other magnetic storage devices, or any other medium capable of storing computer-readable instructions.

Computer 700 may include or have access to a computing environment that includes input interface 706, output interface 704, and a communication interface 716. Output interface 704 may include a display device, such as a touchscreen, that also may serve as an input device. The input interface 706 may include one or more of a touchscreen, touchpad, mouse, keyboard, camera, one or more device-specific buttons, one or more sensors integrated within or coupled via wired or wireless data connections to the computer 700, and other input devices. The computer may operate in a networked environment using a communication connection to connect to one or more remote computers, such as database servers. The remote computer may include a personal computer (PC), server, router, network PC, a peer device or other common data flow network switch, or the like. The communication connection may include a Local Area Network (LAN), a Wide Area Network (WAN), cellular, Wi-Fi, Bluetooth, or other networks. According to one embodiment, the various components of computer 700 are connected with a system bus 720.

Computer-readable instructions stored on a computer-readable medium are executable by the processing unit 702 of the computer 700, such as a program 718. The program 718 in some embodiments comprises software to implement one or more methods described herein. A hard drive, CD-ROM, and RAM are some examples of articles including a non-transitory computer-readable medium such as a storage device. The terms computer-readable medium, machine readable medium, and storage device do not include carrier waves or signals to the extent carrier waves and signals are deemed too transitory. Storage can also include networked storage, such as a storage area network (SAN). Computer program 718 along with the workspace manager 722 may be used to cause processing unit 702 to perform one or more methods or algorithms described herein.

Although a few embodiments have been described in detail above, other modifications are possible. For example, the logic flows depicted in the figures do not require the particular order shown, or sequential order, to achieve desirable results. Other steps may be provided, or steps may be eliminated, from the described flows, and other components may be added to, or removed from, the described systems. Other embodiments may be within the scope of the following claims.

1. A theft detection system comprising:
a sensor having a magnetic ball axially moveably supported within an axial opening in the spool having an electrical coil wound around the spool such that movement of the ball creates electrical signals in the coil;
a housing for supporting and vibrationally coupling the sensor to a vehicle exhaust system; and
a circuit coupled to the electrical coil to receive the electrical signals and generate an alarm signal in response to movement of the ball being indicative of vibration of the exhaust system resulting from exhaust system tampering.

2. The system of claim 1 wherein the housing comprises:
a block having a hole sized to fit the spool and close off a first end of the opening;
a cover coupled to the block to close off the hole and close off a second end of the opening; and
a clamp to rigidly couple the block to a pipe of the exhaust system such that vibration of the pipe is transmitted to the spool.

3. The system of claim 2 wherein the pipe is upstream or downstream of a catalytic converter of the exhaust system.

4. The system of claim 2 wherein the axial opening is axially aligned with vibrations of the exhaust system resulting from tampering.

5. The system of claim 1 wherein the magnetic ball is formed of neodymium.

6. The system of claim 1 wherein the housing and ball are sized such that the ball moves axially within the opening in response to vibrations in the 10-17 Hz range.

7. The system of claim 1 wherein the circuit is coupled to the coil via a twisted pair of conductors.

8. The system of claim 1 wherein the circuit comprises:
a comparator coupled to the coil to generate logic signals representative of tampering; and
a processor configured to:
sample the logic signals;
compare the sampled logic signals to a threshold; and
generate an alarm signal in response to the sampled logic signals exceeding the threshold.

9. The system of claim 1 wherein the circuit comprises:
a comparator coupled to the coil to generate logic signals with a logic 1 corresponding to movement of the magnetic ball and a logic zero representative of no movement of the magnetic ball; and
a processor configured to:
sample the logic signals for a first period of time;
generate a sum of the logic signals for each of multiple sub-periods of time corresponding to the first period of time;
compare each sum to a first threshold;
count the number of sub-period sums exceeding the first threshold; and
generate an alarm signal in response to the number of sub-period sums exceeding the first threshold exceeding a second threshold.

10. The system of claim 8 wherein the number of samples during the first period of time is greater than 10,000, wherein the first threshold is one half the number of samples.

11. The system of claim 9 wherein the second threshold is one half the number of sub-periods.

12. The system of claim 8 and further comprising stopping the alarm signal in response to a signal from a FOB.

13. The system of claim 8 and further comprising preventing the alarm signal in response to a signal indicative of a vehicle engine running.

14. A computer implemented method comprising:
receiving logic signals representative of axial movement of a magnetic ball disposed within a coil;
sampling the logic signals for a first period of time;
generating a sum of the logic signals for each of multiple sub-periods of time corresponding to the first period of time;
comparing each sum to a first threshold;
counting the number of sub-period sums exceeding the first threshold; and
generating an alarm signal in response to the number of sub-period sums exceeding the first threshold exceeding a second threshold.

15. The method of claim 13 wherein the first period of time is one second or longer.

16. The method of claim 14 wherein there are 8 or more sub-periods.

17. The method of claim 13 wherein the number of samples during the first period of time is greater than 10,000, wherein the first threshold is one half the number of samples.

18. (canceled)

19. The system of claim 13 and further comprising stopping the alarm signal in response to a signal from a FOB.

20. The system of claim 13 and further comprising preventing the alarm signal in response to a signal indicative of a vehicle engine running.

21. A device comprising:
a processor; and
a memory device coupled to the processor and having a program stored thereon for execution by the processor to perform operations comprising:
receiving logic signals representative of axial movement of a magnetic ball disposed within a coil;
sampling the logic signals for a first period of time;
generating a sum of the logic signals for each of multiple sub-periods of time corresponding to the first period of time;
comparing each sum to a first threshold;
counting the number of sub-period sums exceeding the first threshold; and
generating an alarm signal in response to the number of sub-period sums exceeding the first threshold exceeding a second threshold.
